(19) United States
(12) Patent Application Publication
(10) Pub. No.: US 2005/0246276 A1
(43) Pub. Date: Nov. 3, 2005

(54) Method for disbursing account payable

(75) Inventors: Yeun-Jong Lee, Taipei (TW); Fang-Chen Tsao, Taipei (TW); Hao-Liang Chen, Taipei (TW); Hui-Shan Ni, Taipei (TW)

Correspondence Address: TROXELL LAW OFFICE PLLC, Suite 1404, 5205 Leesburg Pike, Falls Church, VA, 22041, US

(73) Assignee: VIA Technologies, Inc.

(21) Appl. No.: 11/179,508

(22) Filed: Jul. 13, 2005

Related U.S. Application Data
(62) Division of application No. 10/106,363, filed on Mar. 27, 2002.

(30) Foreign Application Priority Data
Aug. 24, 2001 (TW) 90120957

(51) Int. Cl. G06F 17/60

(52) U.S. Cl. 705/40; 705/30

(57) ABSTRACT

A method for disbursing account payables includes at least the following steps: first, users enter intended sifting payable expenditure conditions in an account payable system; then the account payable system sifts and selects payable expenditures conforming to the payable expenditure conditions; then users select intended disbursing payable expenditures from the payable expenditures conforming to the payable expenditure conditions; then the account payable system summarizing contents of at least one payable document, and the intended disbursing payable expenditures that have same payable expenditure conditions are summarized in the contents of the payable document; thereafter users order the account payable system generating a payment batch number corresponding to all the payable documents; then users enter current intended settlement amount and current deductible amount for any one of the payable documents; and users order the account payable system calculating payable amount contained in the payment batch number; then users order the account payable system to print all payable documents corresponding to the payment batch number to allow people in charge to review and decide whether to make payments. The printed data for the payment batch number include at least payable expenditures contained in the payment batch number.

### FIELD OF THE INVENTION

The present invention relates to a method for disbursing account payable and particularly to a method for disbursing account payable adopted for use in an Enterprise Resource Planning (ERP) system.

### BACKGROUND OF THE INVENTION

Account payable is an obligation an enterprise owes a party resulting from procuring merchandises or materials and receiving services provided by the party on credit. Disbursement of account payable in general account payable systems can be categorized in two types as follows:
1. Item by item settlement: This method mainly base on vendor invoices or shipping documents or the like to search the entered but unpaid account payable detailed data, and manually compare and select intended settlement items, then enter data of the settlement amounts and deductible amounts. The system calculates payment amounts, and people in charge reviews and approves, then the payments are disbursed, and the transactions are entered and books are updated.
2. Regular and periodical settlement: In this method, accounting people summarize entered but unpaid account payable data and deductible amounts at the end of each month or a selected time period, then through human judgement to calculate payments to be made for the current time period. Payments are made after having been reviewed and approved by people in charge, then the transactions are entered and books are updated.

The following is a practical example of a conventional account payable system which adopts the item by item settlement method. The process flow is depicted as follows (also referring to FIG. 1):

As shown in FIG. 1, first, users activate the account payable system to process input operations of the account payable (step 102); then users based on vendor invoices or shipping documents or the like to search entered but unpaid account payable detailed data of the vendor (step 104); then users, based on the entered but unpaid account payable details, select an intended settlement account payable item that matches vendor documents and enter the settling amount (step 106); users, based on deductible payment reports or inquiry data displayed on the screen, enter deductible amount (step 108).

Then the account payable system based on the settling amount and deductible amount calculates the payment due (i.e. payment due is the difference of the settling amount and deductible amount) (step 110); then users request the account payable system to print statements of disbursement or payment slips (step 112); then people in charge reviews the statements of disbursement or payment slips and decides whether to approve the payment for the selected account payable (step 114); if the people in charge approves the payment, disbursement processes are executed to issue payment bills or remittance to the selected vendor (step 116); if the people in charge decides to withhold the payment, the process goes back to step 102 to repeat input operations of the account payable process.

The account payable process for item by item settlement set forth above has the following disadvantages: human operation procedures are very complicated. When there are a lot of account payable transactions, to settle every transaction by individual document is very tedious and time-consuming. While payment records entered in books corresponding to vendors' documents can help future tracking and references, the process creates a huge burden to human resources. And the incurred disbursement operation workload also is heavy.

The following is another practical example of a conventional account payable system which adopts regular and periodical settlement approach. The process flow is depicted as follows (also referring to FIG. 2):

As shown in FIG. 2, first, users activate the account payable system to process input operations of the account payable (step 202); then users input data of payment deadlines on the payable documents in the account payable system (step 204); then users input vendor data of intended payment in the account payable system (step 206); the account payable system based on the deadlines and vendor data searches all account payable details which have been entered but unpaid, and summarizes all account payable amounts in an account payable total amount (step 208); then users based on deductible payment reports or inquiry data displayed on the screen enter deductible amount (step 210).

Then users based on total account payable amount and deductible amount enter payment amount for the current time period (the current payment is less than the difference of the total account payable amount and the deductible amount) (step 212); then the account payable system based on the settlement amount and deductible amount calculates unpaid account payable balance (i.e. unpaid account payable balance=total account payable amount−current payment−deductible amount) and transfers to the next processing cycle (step 214).

Then account payable system determines whether the users requesting to process account payable data for other vendors (step 216); if the users request to process account payable data for other vendors, return to step 204, and renew entering payment deadlines data in the account payable system; if the users do not request to process account payable data for other vendors, the account payable system prints statements of disbursement or payment slips (step 218); then people in charge reviews the statements of disbursement or payment slips and decides whether to approve the payment for the selected account payable (step 220); if the people in charge approves the payment, disbursement processes are executed to issue payment bills or remittance to the selected vendor (step 222); if the people in charge decides to withhold the payment, the process goes back to step 202 to repeat input operations of the account payable process.

The account payable process for regular and periodical settlement set forth above has the following disadvantages: vendors are requested to cooperate for receiving regular and periodic payments, and vendor documents for payable expenditures entered in the books could be huge and tracking could be very difficult. Moreover, before entering deductible amounts, they must be printed in details in advance or be inquired on the display screen. It creates additional operations.

In addition, the two methods set forth above (item by item settlement, and regular and periodical settlement) generally do not include processes for cash discount on early payment. Early payment usually is decided or approved by finance chiefs. There is no automatic notice. Moreover, actual payment after the account payable processes must be done manually, and a lot of manpower are spent on calculating service and transaction fees related to the banks involved in the payment transactions, such as remittance fees, post and telegraph fees, foreign currency remittance fees and exchange rate differences, etc.

Therefore the problems incurred to aforesaid conventional account payable methods are critical issues remain to be resolved.

### SUMMARY OF THE INVENTION

The primary object of the invention is to provide a method to disburse account payable that enables users to set sifting conditions and to process disbursement of account payable by batch approach.

Another object of the invention is to provide a method to automatically calculate cash discount for early payment, and service and transaction fees incurred to the involved banks (such as fees for remittance, post and telegraph, etc.), or exchange rate differences when purchasing or making transactions in foreign currencies.

The method according to an embodiment of the invention for disbursing account payable includes at least the following steps:

First, users enter intended sifting payable expenditure conditions into an account payable system; then the account payable system based on the payable expenditure conditions searches and selects payable expenditures that conform to the payable expenditure conditions; then users select intended disbursing payable expenditures among the payable expenditures that conform to the payable expenditure conditions; then the account payable system summarizes contents of at least one payable document, and the intended disbursing payable expenditures that have same payable expenditure conditions are summarized in the contents of the payable document; thereafter, users order the account payable system to generate a payment batch number corresponding to all payable documents; then users enter current intended settlement amount and deductible amount for any payable document.

Thereafter, the account payable system calculates the payable amount for the payment batch number. The payable amount for the payment batch number is the sum of current payable expenditures of all payable documents, and the current payable expenditure of any payable document is the difference of the current intended settlement amount and current deductible amount for the payable document.

After the account payable system calculated and reached the payable amount for the payment batch number, the following processes are executed: users order the account payable system to print all payable documents corresponding to the payment batch number to enable decision making people to review and decide whether to make the payment; the printed data for the payment batch number include at least payable amount for the payment batch number. The payable expenditure conditions set forth above include payment deadlines for the payable expenditures, vendor, currency, payable type, or payment method, etc. When the intended disbursing payable expenditures that conform to the payable expenditure conditions have been selected, alterations may be made. In the method discussed above, prior to ordering the account payable system to generate the payment batch number corresponding to the payable documents, validity of payment contents in the payable documents must be confirmed. The deductible amount mentioned above includes cash discounts, and deductible account receivables. The cash discount may be input by users or automatically calculated by the system. The alterations of the payable expenditures may include changes of payment method of the payable expenditures, time period or due date of bills.

In addition, prior to users ordering the account payable system to print all payable documents corresponding to the payment batch number, the following operations are processed: users enter or alter detailed data related to banks that handle the payment transactions, account numbers, and calculations for service fees purchasing of foreign currencies, etc.

In the event that errors are found in the payment contents on the payable documents, users may make alterations on the payable documents or redo processes for selecting the intended disbursing payable expenditures among the payable expenditures that conform to the payable expenditure conditions. In addition, after users process entering or altering detailed data related to banks that handle the payment transactions, account numbers, and calculations for service fees, purchasing of foreign currencies, the following operations are processed: users preview ledgers and check credit and debit data.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 a process flow for a conventional account payable system, for settling and disbursing account payable item by item.

FIG. 2 is a process flow for a conventional account payable system, for settling and disbursing account payable regularly and periodically.

FIG. 3 is an embodiment of the invention, showing a display screen for payable expenditures batch disbursing operations in the method for disbursing account payable in the account payable system.

FIG. 4 is an embodiment of the invention, showing a display screen for payable expenditures sifting operation in the method for disbursing account payable in the account payable system.

FIG. 5 is an embodiment of the invention, showing a display screen for payment batch number details operation in the method for disbursing account payable in the account payable system.

FIG. 6 is an embodiment of the invention, showing a display screen for payable voucher details—account payables settlement due operation in the method for disbursing account payable in the account payable system.

FIG. 7 is an embodiment of the invention, showing a display screen for payable voucher details—deductible account receivables operation in the method for disbursing account payable in the account payable system.

FIG. 8 is an embodiment of the invention, showing a display screen for payable voucher details—disbursing payments operation in the method for disbursing account payable in the account payable system.

FIG. 9 is an embodiment of the invention, showing a display screen for payable voucher details—preview ledgers operation in the method for disbursing account payable in the account payable system.

FIG. 10 is a process flow for disbursing account payables according to an embodiment of the invention.

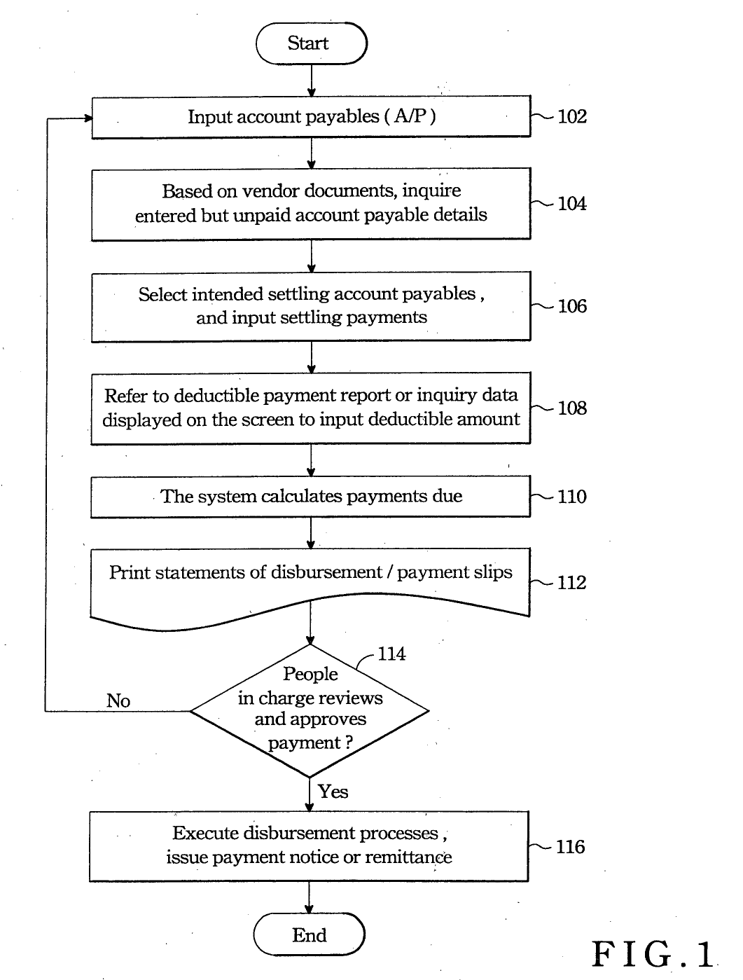

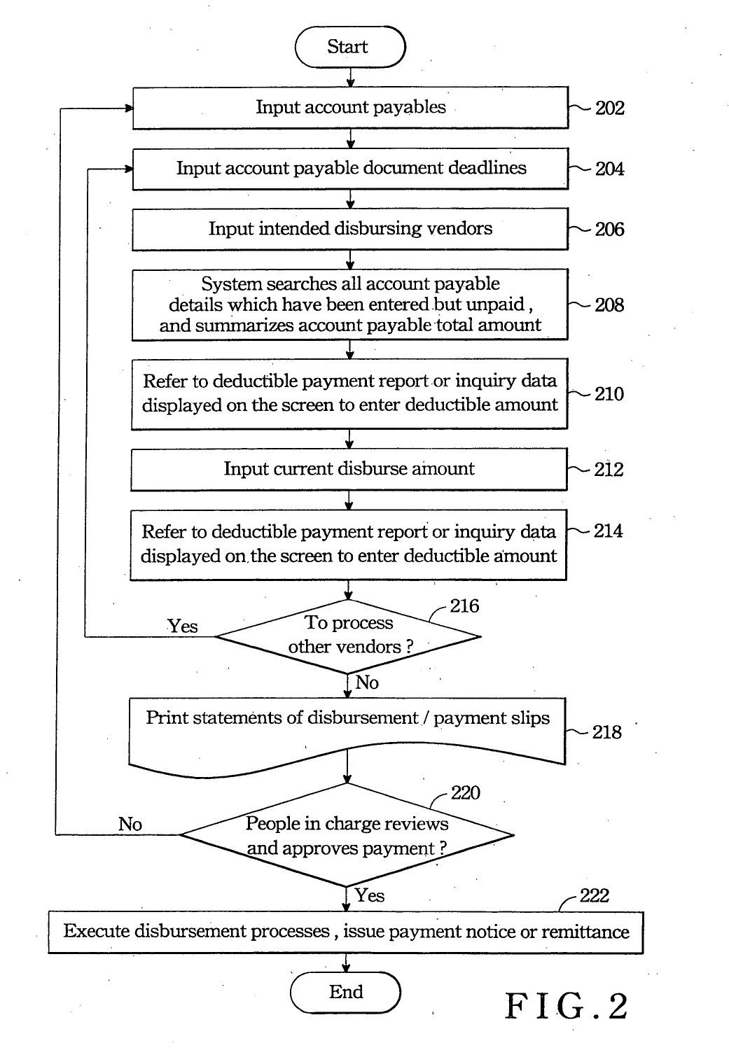

### DETAILED DESCRIPTION OF THE INVENTION

The invention mainly aims to provide a method for disbursing account payable. The method includes at least the following steps: first, input intended sifting payable expenditure conditions in a computer system (or called Account Payable system); then the system sifts and selects payable expenditures that conform to the payable expenditure conditions; then select intended disbursing payable expenditures among aforesaid payable expenditures; the computer system summarizes contents of at least one payable document, and the intended disbursing payable expenditures that have same payable expenditure conditions are summarized in the contents of the payable document; then the computer system generates a payment batch number corresponding to all payable documents; then input current intended settlement amount corresponding to any of the payable documents, and current deductible amount; thereafter, the computer system calculates the payable amount for the payment batch number, the payable amount for the payment batch number is the sum of current payable expenditures of all payable documents in the payment batch number, and the current payable expenditure of any payable document is the difference of the current intended settlement amount and current deductible amount for the payable document; then the computer system prints all payable documents corresponding to the payment batch number to enable decision making people to review and decide whether to make the payment; the printed data for the payment batch number include at least payable amount for the payment batch number.

The method discussed above further includes, prior to the computer system generating the payment batch number corresponding to the payable documents, validating payment contents on the payable documents. If errors are found in the payment contents, redo the processes of selecting intended disbursing account payable among the payable expenditures conforming to the payable expenditure conditions. In addition, prior to the computer system printing all payable documents corresponding to the payment batch number, the method of the present invention further includes processes of entering or altering detailed data related to banks that handle the payment transactions, account numbers, calculating service fees, purchasing of foreign currencies, and previewing the ledgers and checking credit and debit data.

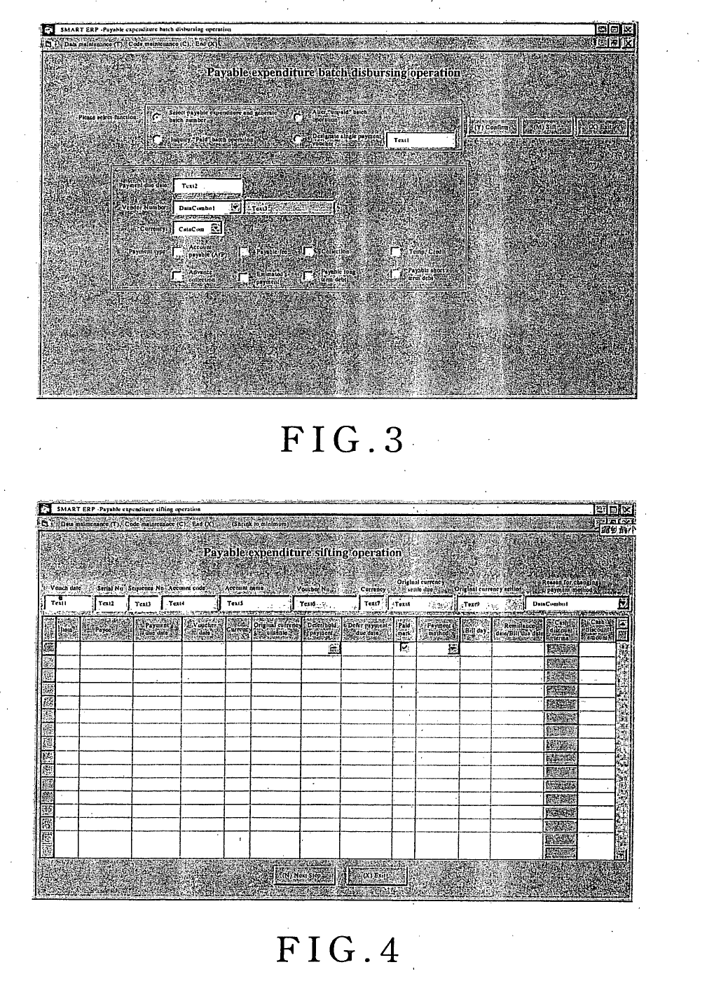

The method for disbursing account payable of the invention may be adopted for use in ERP systems. FIGS. 3 through 9 illustrate system display panels of an embodiment according the invention.

In the invention, account payables that are entered in books but unpaid may be processed through a payable expenditure batch operation in an account payable system (as shown in FIG. 3), including entering intended sifting payable expenditure conditions, such as payment due date, vendor, currency, payment type, and the like. And one of the following functions may be selected: sift and select payable expenditures and generate batch numbers, batch operations for altering unpaid expenditures, batch operations for inquiring paid expenditures, designate a single payment document. When users execute function selection of “sift payable expenditures and generate batch numbers”, users depress the “Sift” button key, the account payable system sifts and selects, according users' designated conditions, payable expenditures with approaching due dates, and displays the selected payable expenditures with the due dates on a payable expenditure sifting display panel (as shown in FIG. 4).

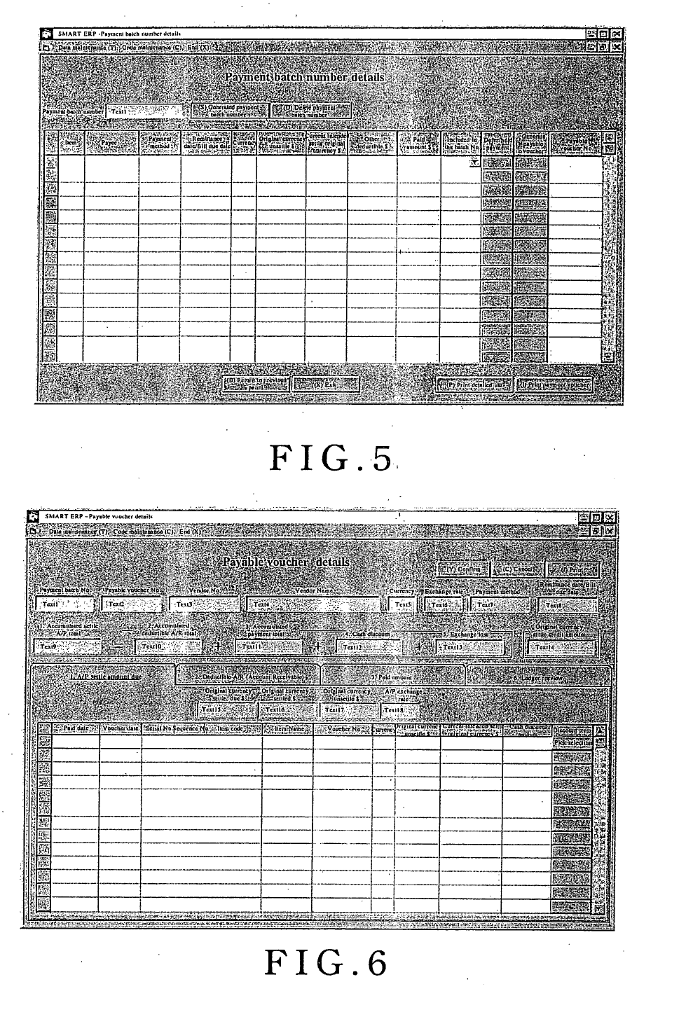

Then users may proceed payable expenditure sifting operations (as shown in FIG. 4), and select the intended disbursing items and confirm payment methods, alter bill time or due dates. The system provides cash discount amount to enable users to decide whether to make early payment. After all selection items have been sifted and selected, depress the “next step” button key to enter payment batch number detail operations (as shown in FIG. 5). The account payable system summarizes data according to same vendor, same payment type, same currency, same bill due date in contents of one payable document. When users confirm that payment contents presented on the display screen (as shown in FIG. 5) in the payment batch number detail operations are correct, depress “generate payment batch number” button key to generate a payment batch number (of course users may decide any serial number to make payment, or include whether defer payment/withhold payment or whether to include in the batch number); otherwise, depress “return to previous screen” button key to return the payable expenditure sifting operations (as shown in FIG. 4) to repeat payable expenditure sifting operations. After the payment batch numbers are generated, users may select to input detailed payable documents to process payable document detail operations. The payable document detail operations include the following four function selection items: account payable settlement due, deductible account receivable, disburse payment, and ledger preview.

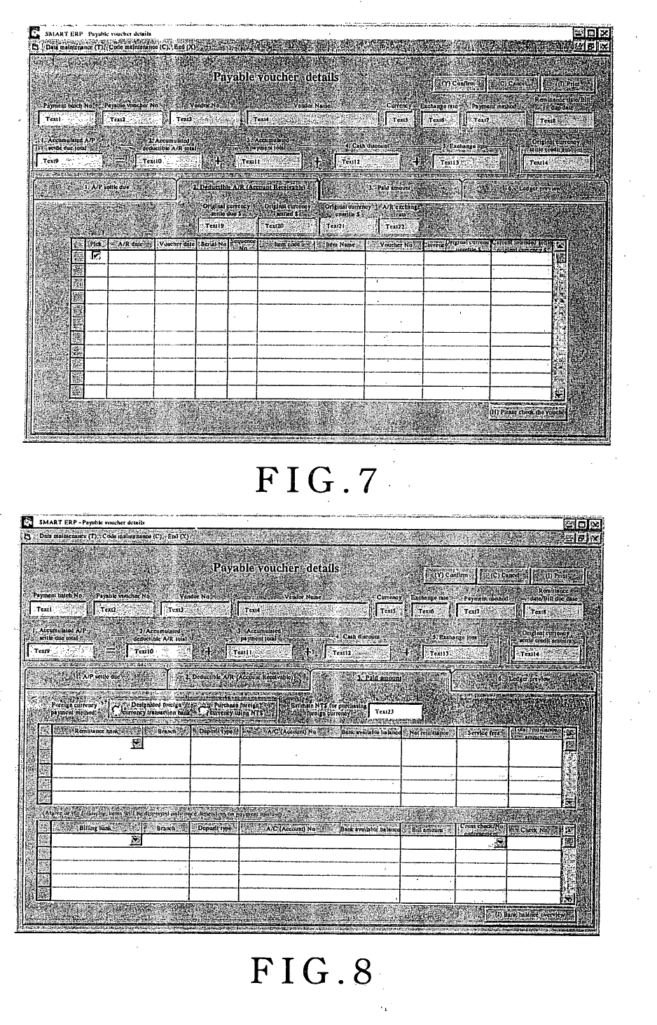

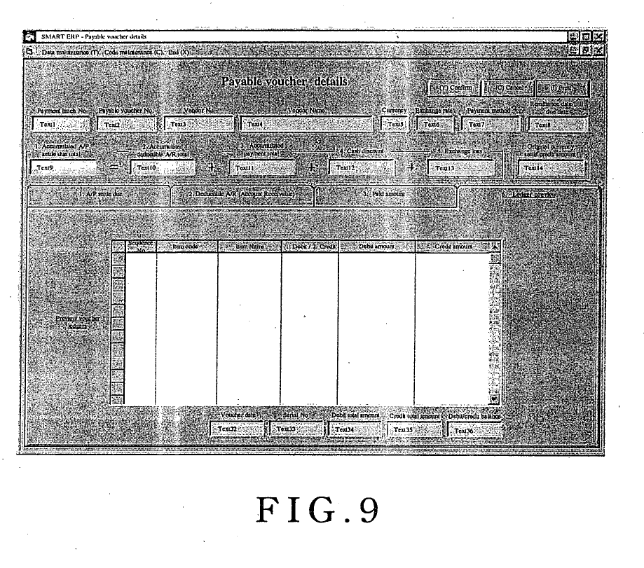

First, users may process payable document detail—account payable settlement due operations (as shown in FIG. 6). In addition to entering data such as current intended settling amount, users may also input or through the system to automatically calculate cash discount on early payment; then users may choose “deductible account receivable” page mark to process payable document detail—deductible account receivable operations (as shown in FIG. 7). Then users may choose “disburse payment” page mark to process payable document detail—disburse payment operations (as shown in FIG. 8). Users may select to alter or enter detailed data related to banks which handle the transactions, account number, service fees, foreign currency purchasing amount, etc. Then users may choose “ledger preview” page mark to process payable document detail—ledger preview operations (as shown in FIG. 9). Users may make primary check and audit through ledger preview, and credit and debit trial balance (including checking detailed data of preview transaction ledgers shown in FIG. 9, and credit totals, debit totals, balance of credit and debit accounts, etc.).

After ledger preview, if users discover that the payment batch number still has detailed items to be processed, repeat selection for input detailed payable documents to repeat processing of the payable document detail operations (as shown in FIG. 6). If there is no other details in the payment batch number to be processed, users may depress “Print” button key, then the account payable system prints the payable documents. Then people in charge of account payable may review the payable documents and decide whether to approve the payment for the recorded account payables. When the people in charge approves the payments, disbursing operations may be proceeded to prepare payment bills or remittances for the vendors. In the event that the people in charge decides that all the payments should be withheld, users may restart the account payable batch operations (as shown in FIG. 3). In addition, if the people in charge decides payments for some of the items should be withheld, the identified items may be excluded from the batch number or held for defer payment.

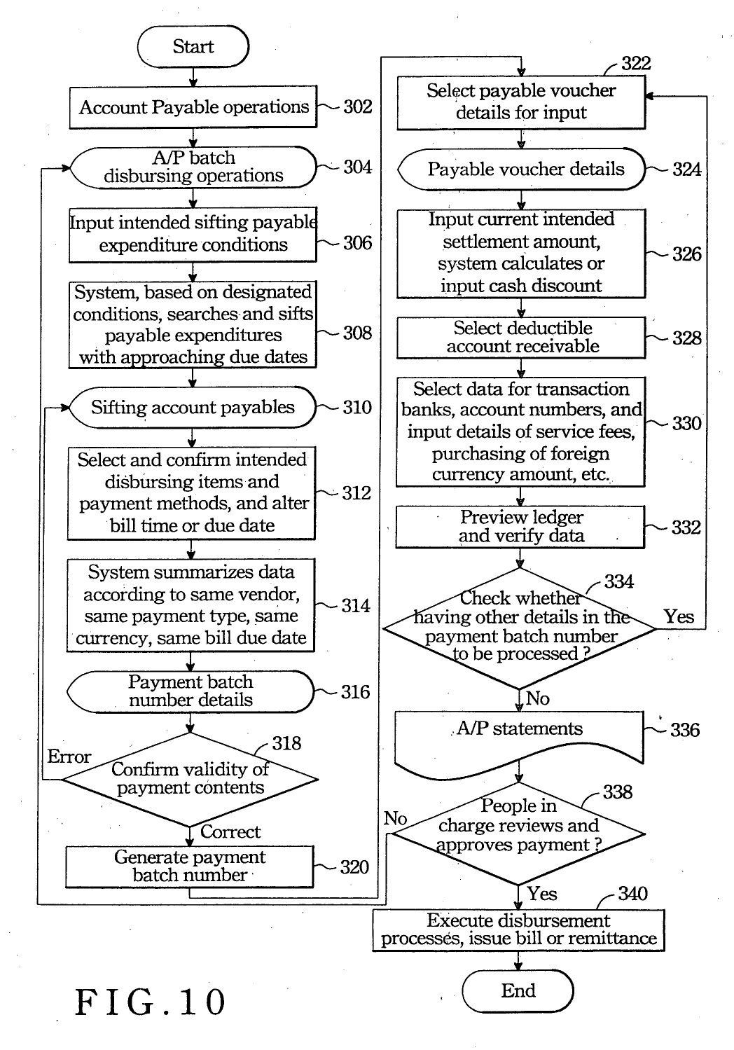

The preferred embodiment of the method for disbursing account payable set forth above may be summarized in a process flow depicted below (also referring to FIG. 10):

As shown in FIG. 10, first, users activate the account payable system to process account payable operations (step 302); then users initiate account payable batch disbursing sub-system to process account payable batch disbursing operations (step 304); then users enter intended sifting payable expenditure conditions (step 306); then the account payable system, based on users' designated sifting conditions, sifts and selects payable expenditures with approaching due dates (step 308); then users activate the account payable sifting sub-system to process account payable sifting operations (step 310).

Then users select the intended disbursement items and confirm payment methods, and alter bill times or due dates (step 312); then the account payable system summarizes data according to same vendor, same payment type, same currency, same due date of bills in contents of one payable document (step 314); then the system automatically activates the payment batch number sub-system (step 316); then users check and confirm validity of payment contents in the payment documents (step 318).

If users confirm that there is no error in the payment contents of the payable documents, then order the account payable system to generate a payment batch number (step 320); if users confirm that there are errors in the payment contents of the payable documents, then return to step 310. After the payment batch number is generated, users may select to input detailed payable documents to process payable document detail operations (step 322); thereafter, users activate payable document detail sub-system (step 324); then users enter current settlement amount or through the system to automatically calculate cash discount (step 326).

Thereafter, users select deductible account receivable (step 328); then users select altering or entering detailed data for transaction banks, account numbers, and service fees, purchasing of foreign currencies, etc. (step 330); then users preview ledger and verify data (step 332); then users confirm whether there are other details in the payment batch number to be processed (step 334).

In the event that there are other details in the payment batch number to be processed, return to step 322; if there is no other details in the payment batch number to be processed, users may order the account payable system to print payable documents (step 336); then people in charge of account payable may review the payable documents and decide whether to approve the payment for the recorded payable expenditures (step 338). If the people in charge approves the payments, disbursing operations may be proceeded to prepare payment bills or remittances for the vendors (step 340). In the event that the people in charge decides that all the payments should be withheld, return to step 304. If the people in charge decides payments for some of the items should be withheld, return to step 316, and payment for the identified items is deferred or withheld, or be excluded from the batch number.

In summary, the invention offers novel features to overcome the disadvantages incurred to conventional techniques, and has the following benefits:
1. The invention provides users various input conditions to sift and select account payables that conform to required conditions, and allows to select and input various payable document details and settlement and deductible data, then processes in a batch mode to proceed approval, disbursing and book keeping operations. Utilization is more flexible. Various numbers of vendor documents can be processed any time without the need of making an entry in the books for every piece of vendor document that otherwise incurs to conventional techniques and systems. The problems of multiple operations and multiple documents for one transaction and difficult to track can also be resolved. Users can flexibly adapt the method of the invention to different circumstances to make payment item by item, or by batch.
2. In the invention, when the payment batch number is not yet established, sifting conditions may be changed. When the payment batch number is established, there are options for partial defer payment or withhold payment. In contrast, defer payment or withhold payment processes in conventional systems can only be determined at the review time by the people in charge, or all payments for a selected target must be deferred or withheld, and setting for a single transaction is not possible.
3. The invention provides instant credit and debit trial balance function, and offers guiding and error correcting function during entering, payment amount or selecting deductible amount data. Users may input data on blank portions or alter data on questionable portions of the trial balance spreadsheet. After all data are input and altered, the ledger preview function allows users to check data validity before printing payable documents and submitting to the people in charge for, reviewing.
4. According to the invention, the system can base on vendor shipping data to determine whether cash discounts are available for selected account payables, and to calculate discount amount based on discount terms and conditions. The works of inquiring data and calculating discount amount by human labor can be saved.
5. On disbursing payments, the invention provides a system that can automatically calculate remittance service fees and payment totals, and also provides input function for altering service fees. The service fees are automatically posted in accounting books. Manual books keeping thus may be saved. The system also provides accurate payment totals, and saves human calculations for service fees, and makes cashiers' operations more convenient.
6. When account payable involves foreign currencies, the invention can automatically retrieves foreign exchange rates at the transaction time, and enables users to input “estimate total local currency for purchasing foreign currencies”, and facilitates interim estimation of exchange rate differences, post and telegraph fees, remittance fees when disburse account payables in foreign currencies. The system automatically records the estimated amount, and entering books when disbursement of foreign currencies is completed. Human books keeping for various fees and multiple books entering operations that incurred to conventional systems can be saved.

While the preferred embodiments of the inventions have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1-11. (canceled)

12. A method for disbursing account payable implemented in a computer system, comprising at least the steps of:
entering intended sifting payable expenditure conditions in the computer system;
the computer system based on the payable expenditure conditions sifting and selecting payable expenditures which conform to the payable expenditure conditions;
selecting intended disbursing payable expenditures from the payable expenditures that conform to the payable expenditure conditions;
the computer system summarizing contents of at least one payable document, and the intended disbursing payable expenditures that have same payable expenditure conditions are summarized in the contents of the payable document;
confirming validity of payment contents in the payable document;
the computer system generating a payment batch number corresponding to all the payable documents after the confirming validity of payment contents in the payable document proving correct;
entering current intended settlement amount for any one of the payable documents and current deductible amount; and
the computer system calculating payable amount contained in the payment batch number, the payable amount being the sum of current payable expenditures contained in all the payable documents, the current payable expenditure of any one of the payable documents being the difference of the current intended settlement amount and the current deductible amount in the payable document.

13. The method of claim 12, wherein the payable expenditure conditions include payment deadline, vendor, currency type, payable type or payment method.

14. The method of claim 12, wherein the selecting intended disbursing payable expenditures from the payable expenditures that conform to the payable expenditure conditions further includes an allowance of being altered thereupon after the intended disbursing payable expenditures have been selected.

15. The method of claim 14, wherein the allowance includes changing upon disbursing methods, time period and due date of bills.

16. The method of claim 12, wherein the step of computer system calculating payable amount contained in the payment batch number is followed by the steps of:
the computer printing all payable documents corresponding to the payment batch number for reviewing to decide whether to make payments, the printed payable documents including at least data of payable amount included in the payment batch number.

17. The method of claim 16, wherein the step of the computer system printing all payable documents corresponding to the payment batch number is preceded by steps of: altering or entering detailed data of transaction banks, account number, service fees, purchasing of foreign currencies.

18. The method of claim 12, wherein the deductible amount include cash discounts, and deductible account receivables.

19. The method of claim 18, wherein the cash discounts are entered by users or automatically calculated by the computer system.

20. The method of claim 12, wherein the step of selecting intended disbursing payable expenditures from the payable expenditures that conform to the payable expenditure conditions is repeated when errors are found in the confirming validity of payment contents in the payable documents.
